(19) United States
(12) Patent Application Publication
(10) Pub. No.: US 2016/0210785 A1
(43) Pub. Date: Jul. 21, 2016

(54) AUGMENTED REALITY SYSTEM AND METHOD FOR POSITIONING AND MAPPING

(71) Applicant: SULON TECHNOLOGIES INC., Markham (CA)

(72) Inventors: Dhanushan BALACHANDRESWARAN, Richmond Hill (CA); Kibaya Mungai NJENGA, Markham (CA); Jian ZHANG, Oakville (CA)

(21) Appl. No.: 14/778,855

(22) PCT Filed: Oct. 3, 2014
(86) PCT No.: PCT/CA2014/050961

§ 371 Date: Sep. 21, 2015

Related U.S. Application Data
(60) Provisional application No. 61/886,437, filed on Oct. 3, 2013.

(51) Int. Cl. G06T 19/00; H04N 13/02; G02B 27/01; G06T 15/00

(52) U.S. Cl. CPC G06T 19/006; G06T 15/005; H04N 13/0203; G02B 27/0172; G02B 2027/0138; G02B 2027/014

(57) ABSTRACT

An augmented reality and virtual reality head mounted display is described. The head mounted display comprises a camera array in communication with a processor to map the physical environment for rendering an augmented reality of the physical environment.

### TECHNICAL FIELD

The following relates generally to systems and methods for augmented and virtual reality environments, and more specifically to systems and methods for mapping a virtual or augmented environment based on a physical environment, and displaying the virtual or augmented environment on a head mounted device.

### BACKGROUND

The range of applications for augmented reality (AR) and virtual reality (VR) visualization has increased with the advent of wearable technologies and 3-dimensional (3D) rendering techniques. AR and VR exist on a continuum of mixed reality visualization.

### SUMMARY

In embodiments, a method is described for mapping a physical environment surrounding a user wearing a wearable display for augmented reality. The method comprises: (i) capturing, by at least one depth camera disposed upon the user, depth information for the physical environment; (ii) by a processor, obtaining the depth information, determining the orientation of the at least one depth camera relative to the wearable display, and assigning coordinates for the depth information in a map of the physical environment based on the orientation of the at least one depth camera.

In further embodiments, a system is described for mapping a physical environment surrounding a user wearing a wearable display for augmented reality. The system comprises: (i) at least one depth camera disposed upon the user, to capture depth information for the physical environment; and (ii) at least one processor in communication with the at least one depth camera, to obtain the depth information from the at least one depth camera, determine the orientation of the at least one depth camera relative to the wearable display, and assign coordinates for the depth information in a map of the physical information based on the orientation of the at least one depth camera.

In still further embodiments, a system is described for displaying a rendered image stream in combination with a physical image stream of a region of a physical environment captured in the field of view of at least one image camera disposed upon a user wearing a wearable display for augmented reality. The system comprises a processor configured to: (i) obtain a map of the physical environment; (ii) determine the orientation and location of the wearable display within the physical environment; (iii) determine, from the orientation and location of the wearable display, the region of the physical environment captured in the field of view of the at least one image camera; (iv) determine a region of the map corresponding to the captured region of the physical environment; and (iv) generate rendered stream comprising augmented reality for the corresponding region of the map.

In yet further embodiments, a method is described for displaying a rendered image stream in combination with a physical image stream of a region of a physical environment captured in the field of view of at least one image camera disposed upon a user wearing a wearable display for augmented reality. The method comprises, by a processor: (i) obtaining a map of the physical environment; (ii) determining the orientation and location of the wearable display within the physical environment; (iii) determining, from the orientation and location of the wearable display, the region of the physical environment captured in the field of view of the at least one image camera; (iv) determining a region of the map corresponding to the captured region of the physical environment; and (v) generating rendered stream comprising augmented reality for the corresponding region of the map.

### DESCRIPTION OF THE DRAWINGS

A greater understanding of the embodiments will be had with reference to the Figures, in which:

FIG. 1 illustrates an embodiment of a head mounted display (HMD) device;

FIG. 2A illustrates an embodiment of an HMD having a single depth camera;

FIG. 2B illustrates an embodiment of an HMD having multiple depth cameras;

FIG. 3 is a flowchart illustrating a method for mapping a physical environment using a depth camera;

FIG. 4 is a flowchart illustrating another method for mapping a physical environment using a depth camera and an orientation detection system;

FIG. 5 is a flowchart illustrating a method for mapping a physical environment using multiple depth cameras;

FIG. 6 is a flowchart illustrating a method for mapping a physical environment using at least one depth camera and at least one imaging camera;

FIG. 7 is a flowchart illustrating a method for determining the location and orientation of an HMD in a physical environment using at least one depth camera and/or at least one imaging camera;

FIG. 8 is a flowchart illustrating a method for generating a rendered image stream of a physical environment based on the position and orientation of an HMD within the physical environment; and

FIG. 9 is a flowchart illustrating a method of displaying an augmented reality of a physical environment by simultaneously displaying a physical image stream of the physical environment and a rendered image stream.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

The present disclosure is directed to systems and methods for augmented reality (AR). However, the term “AR” as used herein may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following refers to “AR” but is understood to include all of the foregoing and other variations recognized by the skilled reader.

A head mounted display (HMD) or other wearable display worn by a user situated in a physical environment may comprise a display system and communicate with: at least one depth camera disposed upon or within the HMD, or worn by (i.e., disposed upon) the user, to generate depth information for the physical environment; and at least one processor disposed upon, or within, the HMD, or located remotely from the HMD (such as, for example, a processor of a central console, or a server) to generate a map of the physical environment from the depth information. The processor may generate the map as, for example, a point cloud, in which the points correspond to the obtained depth information for the physical environment.

Mapping a physical environment from a scanning system tied to the user may be referred to as inside-out mapping or first-person-view mapping. In contrast, outside-in mapping involves mapping a physical environment from one or more scanning systems situated in the physical environment and directed to scan towards one or more users. It has been found that user engagement with an AR may be enhanced by allowing a user to move throughout a physical environment in an unconstrained manner. Inside-out mapping may provide greater portability because mapping of a physical environment is performed by equipment tied to a user rather than the physical environment.

The processor further generates an AR (also referred to as “rendered”) image stream comprising computer-generated imagery (CGI) for the map, and provides the AR image stream to the display system for display to the user. The processor may continuously adapt the rendered image stream to correspond to the user's actual position and orientation within the physical environment. The processor may therefore obtain real-time depth information from the depth camera to determine the user's real-time orientation and location with the physical environment, as described herein in greater detail. The processor provides the rendered image stream to the display system for display to the user.

The display system of the HMD may display an image stream of the physical environment, referred to herein as a “physical image stream”, to the user. The display system obtains the image stream from at least one image camera disposed upon the HMD or the user, either directly, or by way of the processor. The at least one image camera may be any suitable image capture device operable to capture visual images of the physical environment in digital format, such as, for example, a colour camera or video camera. In operation, the at least one image camera dynamically captures the physical image stream for transmission to the display system.

The display system may further simultaneously display the physical image stream provided by the at least one image camera, and the rendered image stream obtained from the processor. Further systems and methods are described herein.

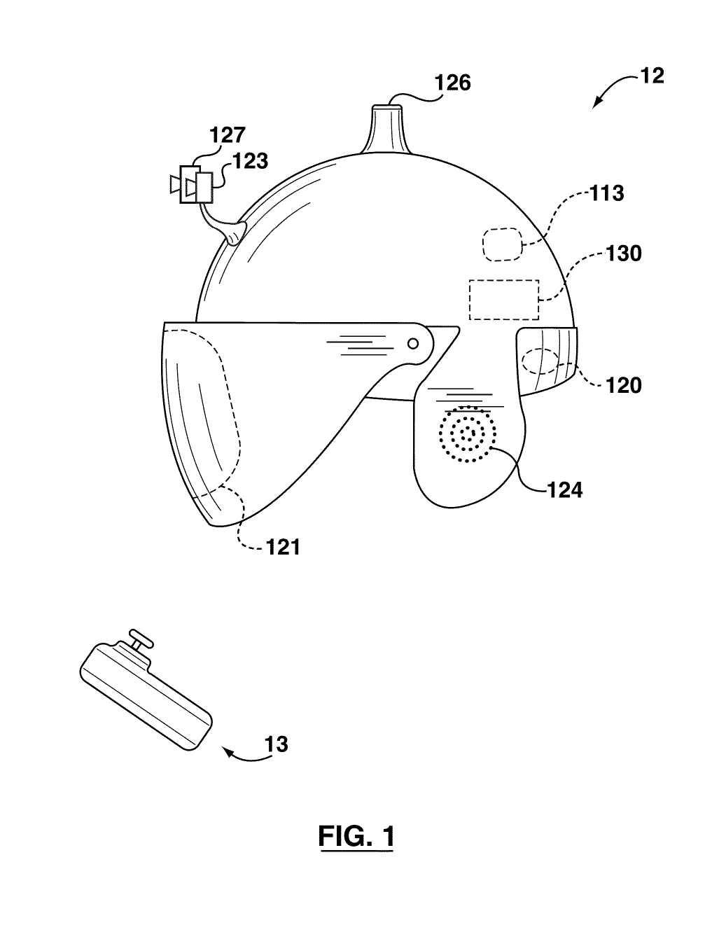

Referring now to FIG. 1, an exemplary HMD 12 configured as a helmet is shown; however, other configurations are contemplated. The HMD 12 may comprise: a processor 130 in communication with one or more of the following components: (i) at least one depth camera 127 (e.g., a time-of-flight camera) to capture depth information for a physical environment, and at least one image camera 123 to capture at least one physical image stream of the physical environment; (ii) at least one display system 121 for displaying to a user of the HMD 12 an AR and/or VR and/or the image stream of the physical environment; (iii) at least one power management system 113 for distributing power to the components; (iv) at least one sensory feedback system comprising, for example, haptic feedback devices 120, for providing sensory feedback to the user; and (v) an audio system 124 with audio input and output to provide audio interaction. The processor 130 may further comprise a wireless communication system 126 having, for example, antennae, to communicate with other components in an AR and/or VR system, such as, for example, other HMDs, a gaming console, a router, or at least one peripheral 13 to enhance user engagement with the AR and/or VR. The power management system may comprise a battery to generate power for the HMD, or it may obtain power from a power source located remotely from the HMD, such as, for example, from a battery pack disposed upon the user or located within the physical environment, through a wired connection to the HMD.

In certain applications, the user views an AR comprising a completely rendered version of the physical environment (i.e., “enhanced VR”). In such applications, the user may determine the locations for obstacles or boundaries in the physical environment based solely on the rendering displayed to the user in the display system 121 of the user's HMD 12.

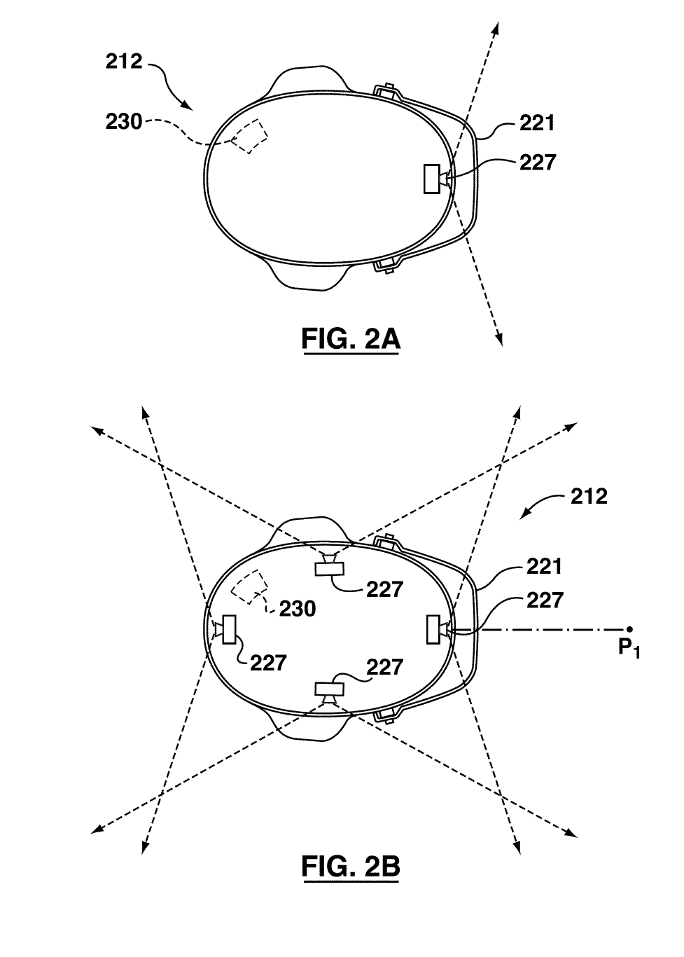

As shown in FIGS. 2A and 2B, an HMD 212 may comprise a display system 221 and at least one depth camera 227, which are both in communication with a processor 230 configured to: obtain depth information from the at least one depth camera 227, map the physical environment from the depth information, and determine substantially real-time position information for the HMD 212 within the physical environment; and generate a rendered image stream for the map based on the real-time position information. As shown in FIG. 2A, the HMD 212 comprises a single depth camera 227 or, as shown in FIG. 2B, multiple depth cameras 227. If the HMD 212 is equipped with multiple depth cameras 227, the multiple depth camera 227 may be disposed at angles to one another, or in other orientation with respect to each other permitting the image cameras to capture, in combination, a wider field of view than a single depth camera 227 might capture. For example, as shown in FIG. 2B, the four depth cameras 227 shown in FIG. 2B, are directed substantially orthogonally with respect to each other and outwardly toward the physical environment with respect to the HMD 212. As configured, the four depth cameras capture a 360 degree view of the regions of the physical environment outside the intersection points of the fields of view of the depth cameras 227. Each of the four depth cameras 227 has a field of view that is sufficiently wide to intersect with the field of view of each of its neighbouring depth cameras 227. It will be appreciated that the field of view of each of the depth cameras 227 is illustrated in FIGS. 2A and 2B by the broken lines extending from each depth camera 227 outwardly from the HMD 212 in the direction of each arrow.

If the at least one depth camera 227 of the HMD 212 has a combined field of view that is less than 360 degrees about the HMD 212, as shown in FIG. 2A, a 360 degree view of the physical space may be obtained if a user wearing the HMD 212 makes a rotation and, possibly a translation, in the physical environment while the at least one depth camera 227 continuously captures depth information for the physical space. However, during the user's rotation, the user's head may tilt front to back, back to front, and/or shoulder to shoulder, such that the continuously captured depth information is captured at different angles over the course of the rotation. Therefore, the processor may invoke a stitching method, as hereinafter described, to align the depth information along the rotation.

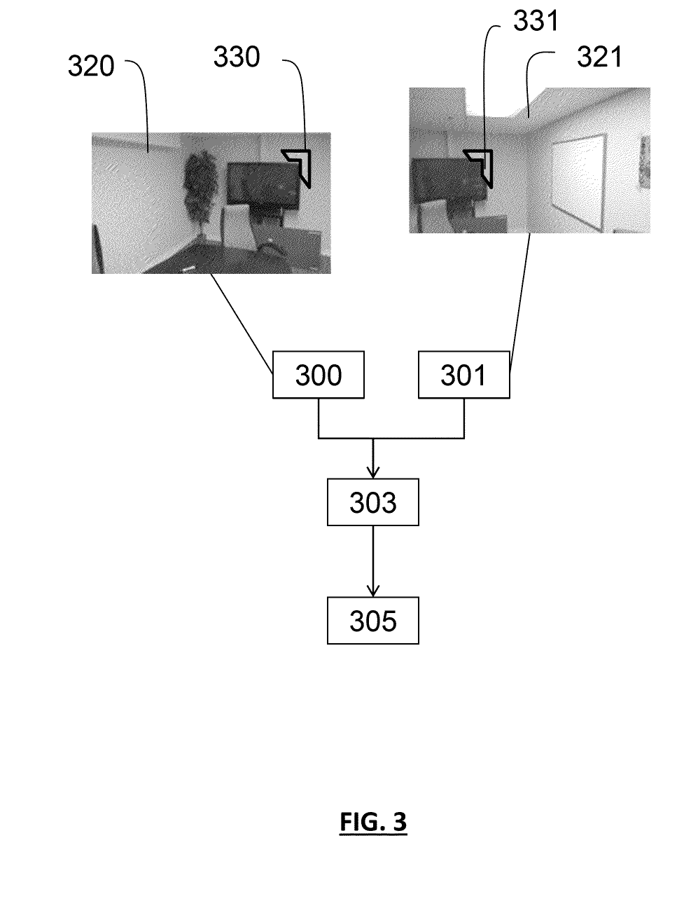

As shown in FIG. 3, at block 300, a depth camera on an HMD captures depth information for a physical space at time t=0. At block 301, the depth camera captures depth information for the physical space at time t=1. Continuously captured depth information may be understood as a series of frames representing the captured depth information for a discrete unit of time.

At block 303, a processor receives the depth information obtained at blocks 300 and 301 during the user's rotation and “stitches” the depth information received during the user's rotation. Stitching comprises aligning subsequent frames in the continuously captured depth information to create a substantially seamless map, as outlined herein with reference to blocks 303 and 305.

The region of the physical space captured within the depth camera's field of view at time t=0 is illustrated by the image 320; similarly, the region of the physical space captured within the depth camera's field of view at time t=1 is illustrated by the image 321. It will be appreciated that the user capturing the sequence shown in FIG. 3 must have rotated her head upwardly between time t=0 and t=1. Still at block 303, the processor uses the depth information obtained at block 300 as a reference for the depth information obtained at block 301. For example, the television shown in the image 320 has an upper right-hand corner represented by a marker 330. Similarly, the same television shown in the image 321 has an upper right-hand corner defined by a marker 331. Further, in both images, the region underneath the markers is defined by a wall having a depth profile. The processor identifies the shared topography corresponding to the markers 330 and 331. At block 305, the processor generates a map of the physical environment by using the depth information captured at block 300 as a reference for the depth information captured at block 301 based on the shared topographical feature or features identified at block 303. For example, if the processor assigns coordinates xₜᵣ, yₜᵣ, zₜᵣ to the top right-hand corner of the television based on the depth information captured at block 300, the processor will then assign the same coordinate to that same corner for the depth information obtained at block 301. The processor thereby establishes a reference point from which to map the remaining depth information obtained at block 301. The processor repeats the processes performed at blocks 303 and 305 for further instances of depth capture at time t>1, until the depth camera has obtained depth information for all 360 degrees.

It will be appreciated that accuracy may be enhanced if, instead of identifying a single topographical feature common to subsequent depth information captures, the processor identifies more than one common topographical feature between frames. Further, capture frequency may be increased to enhance accuracy.

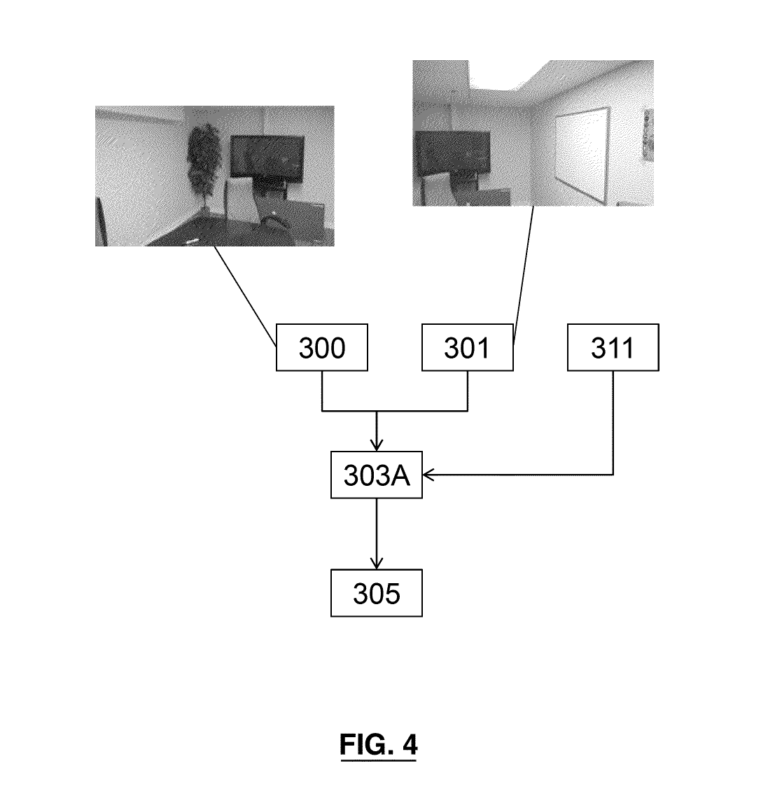

Alternatively, or in addition, to identifying common features between subsequent frames captured by the at least one depth camera, the processor may obtain real-time orientation information from an orientation detecting system for the HMD, as shown in FIG. 4. The HMD may comprise an inertial measurement unit, such as a gyroscope or accelerometer, a 3D magnetic positioning system, or other suitable orientation detecting system to provide orientation information for the HMD to the processor, at block 311. For example, if the orientation detecting system is embodied as an accelerometer, the processor may obtain real-time acceleration vectors from the accelerometer to calculate the orientation of the HMD at a point in time. At block 303A, the processor associates the real-time orientation of the HMD to the corresponding real-time depth information. At block 305, as previously described, the processor uses the depth information obtained at block 300 as a reference for depth coordinates captured at block 302. However, instead of, or in addition to, the identifying of at least one topographical common element between the first captured depth information and the subsequently captured depth information, the processor uses the change in orientation of the HMD at the time of capture of the subsequent information (as associated at block 303A) to assign coordinates to that depth information relative to the first captured depth information. The processor repeats steps 303A and 305 for further subsequently captured depth information until the depth camera has obtained depth information for all 360 degrees about the HMD, thereby generating a 360 degree map of the physical environment.

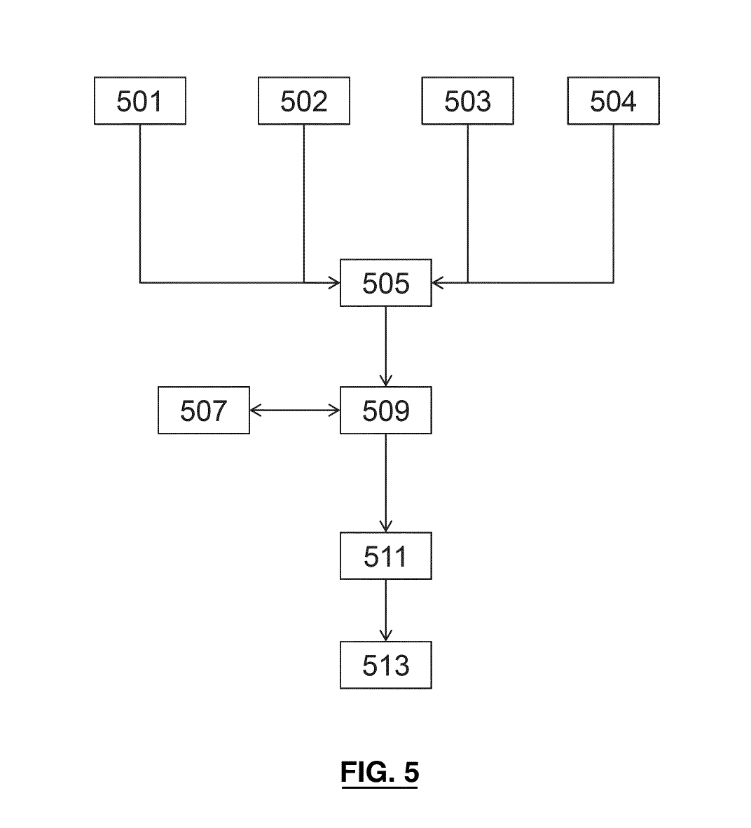

As shown in FIG. 2B, the HMD 212 may comprise an array of depth cameras 227, such as, for example, four depth cameras 227, configured to obtain depth information for the physical space for all 360 degrees about the HMD 212, even though the HMD 212 may remain stationary during depth capture for mapping. As shown in FIG. 5, a first, second, third and fourth depth camera each captures depth information for the physical environment, at blocks 501, 502, 503 and 504, respectively. All depth cameras may capture the depth information substantially simultaneously. The processor obtains the depth information from the depth cameras, at block 505. The processor identifies each camera and its respective depth information by a unique ID. At block 509, the processor obtains from a memory the orientation of each depth camera relative to the HMD, which is associated in the memory to the unique ID of the depth camera, at block 507. At block 511, the processor generates a map for the physical environment based on the depth information received from, and the orientation of, each of the depth cameras. The processor assigns a coordinate in the map for each point in the depth information; however, since each of the depth cameras in the array is directed toward a different direction from the other depth cameras, the processor rotates the depth information from each depth camera by the rotation of each depth camera from the reference coordinate system according to which the processor maps the physical environment. For example, with reference to FIG. 2B, the processor may render the point P₁ on the map as the base point from which all other points in the map are determined by assigning map coordinates x, y, z=0, 0, 0. It will be appreciated, then, that the forward-facing depth camera 227 which generates the depth information for point P₁, may return depth information that is already aligned with the map coordinates. However, at block 511, the processor adjusts the depth information from the remaining depth cameras by their respective relative orientations with respect to the forward-facing depth camera. The processor may thereby render a map of the physical environment, at block 513.

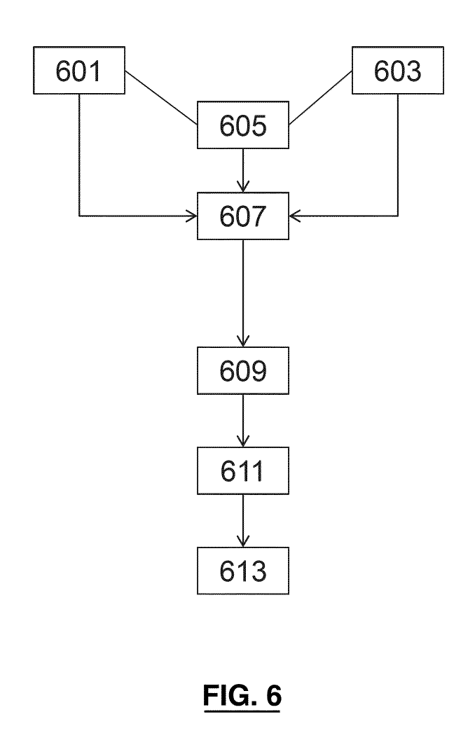

The HMD may further comprise at least one imaging camera to capture a physical image stream of the physical environment. The processor may enhance the map of the physical environment generated using depth information from the at least one depth camera by adding information from the physical image stream of the physical environment. During mapping according to the previously described mapping methods, the processor may further obtain a physical image stream of the physical environment from the at least one imaging camera, as shown in FIG. 6. The at least one imaging camera captures a physical image stream of the physical environment, at block 601. Substantially simultaneously, the at least one depth camera captures depth information for the physical environment, at block 603. At block 609, the processor obtains the depth information from the at least one depth camera and the physical image stream of the physical environment from the at least one imaging camera. Each imaging camera may have a predetermined relationship, in terms of location, orientation and field of view, with respect to the at least one depth camera, defined in a memory at block 605. The processor obtains the definition at block 607. At block 609, the processor assigns depth data to each pixel in the physical image stream based on the depth information and the predetermined relationship for the time of capture of the relevant pixel. At block 611, the processor stitches the physical images captured in the physical image stream using stitching methods analogous to those described above, with suitable modification for images, as opposed to depth data. For example, the processor may identify common graphic elements or regions within subsequent frames. At block 613, the processor generates an image and depth map of the physical environment.

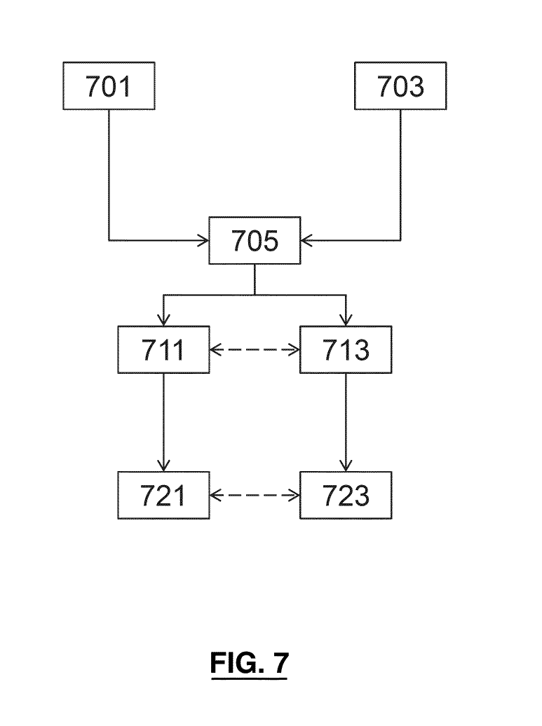

Once the processor has mapped the physical environment, the processor may track changes in the user's orientation and position due to the user's movements. As shown in FIG. 7, at block 701, the at least one image camera continues to capture a physical image stream of the physical environment. Further, or alternatively, the at least one depth camera continues to capture depth information for the physical environment at block 703. At block 705, the processor continues to obtain data from each or either of the real-time image stream and depth information. At block 711, the processor may compare the real-time image stream to the image map generated according to, for example, the method described above with reference to FIG. 6, in order to identify a graphic feature common to a mapped region and the image stream. Once the processor has identified a common region, it determines the user's location and orientation with respect to the map at a point in time corresponding to the compared portion (i.e., frame) of the image stream. By determining the transformation required to scale and align the graphic feature in the physical image stream with the same graphic feature in the image map, the processor may determine the user's position and orientation with reference to the map. Further, or alternatively, the processor may perform an analogous method for depth information obtained in real-time from the at least one depth camera. At block 713, the processor identifies a topographical feature for a given point in time in the real-time depth information, and also identifies the same topographical feature in the depth map of the physical environment. At block 723, the processor determines the transformation required to scale and align the topographical feature between the real-time depth information and the depth map in order to determine the user's position and orientation at the given point in time. The processor may verify the position and orientation determined at blocks 721 and 723 with reference to each other to resolve any ambiguities, or the common regions identified at blocks 711 and 713. For example, if the image map for the physical environment comprises two or more regions which are graphically identical, a graphical comparison alone would return a corresponding number of locations and orientations for the HMD; however, as shown by the dashed lines in FIG. 7, the processor may use the depth comparison to resolve erroneous image matching, and vice versa.

Alternatively, the HMD may comprise a local positioning system and/or an orientation detecting system, such as, for example, a 3D magnetic positioning system, laser positioning system and/or inertial measurement unit to determine the real-time position and orientation of the user.

Augmented reality involves combining CGI (also understood as renderings generated by a processor) with a physical image stream of the physical environment. An HMD for AR and VR applications is shown in FIG. 1, as previously described. The display system 121 may be operable to receive either a combined image stream (i.e., a physical image stream and a rendered image stream) from the processor, or to simultaneously receive a physical image stream from the at least one imaging camera and the rendered image stream from the processor, thereby displaying an AR to the user of the HMD 12. The processor generates a rendered image stream according to any suitable rendering techniques for display on the display system of the HMD. The rendered image stream may comprise, for example, CGI within the map of the physical environment.

The display system of an HMD may display the rendered image stream alone (enhanced VR) or overlaid over the physical image stream to combine the visual and typographic aspects of the physical environment (AR).

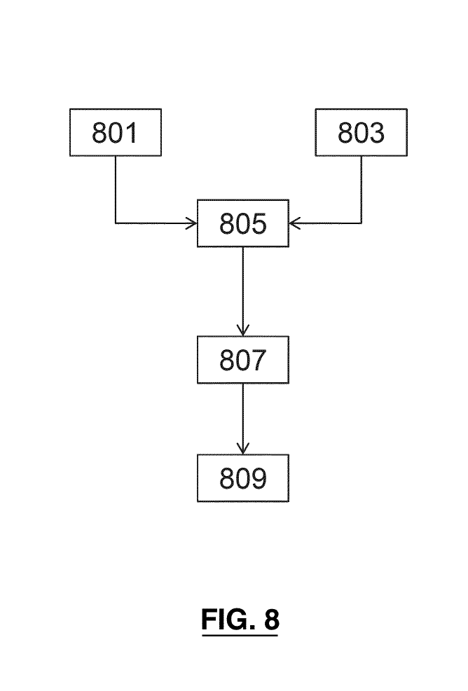

In an enhanced VR application, the processor may enhance a user's interaction with the physical environment by accounting for the user's real-time location and orientation within the physical environment when generating the rendered image stream. As the user moves about the physical environment, the VR of that physical environment displayed to the user will reflect changes in the user's position and/or orientation. As shown in FIG. 8, at block 801, the processor determines the orientation and location of the user's HMD according to any suitable method, including the orientation and positioning methods described above. In an enhanced VR application, parameters corresponding to a notional or virtual camera may be defined, at block 803, in a memory accessible by the processor. For example, the notional camera may have a defined notional field of view and relative location on the HMD. At block 805, the processor determines which region of the map lies within the field of view of the notional camera based on the orientation and location information obtained at block 801 in conjunction with the camera parameters defined at block 803. At block 807, the processor generates a rendered image stream of the region of the map lying within the notional field of view, including any CGI within that region. At block 809, the display system of the HMD may display the rendered image stream in substantially real-time, where processing time for generating the image stream is responsible for any difference between the actual and orientation and location, and the displayed notional orientation and location, of the user's HMD.

In an AR application, the display system of an HMD may display the rendered image stream overlaid over, or combined with, the physical image stream. When the at least one image camera captures an image stream of the physical environment, the captured physical image stream at any given moment will comprise elements of the physical environment lying within the field of view of the camera at that time.

The physical image stream obtained by the camera is either transmitted to the processor for processing and/or transmission to the display system, or directly to the display system for display to the user.

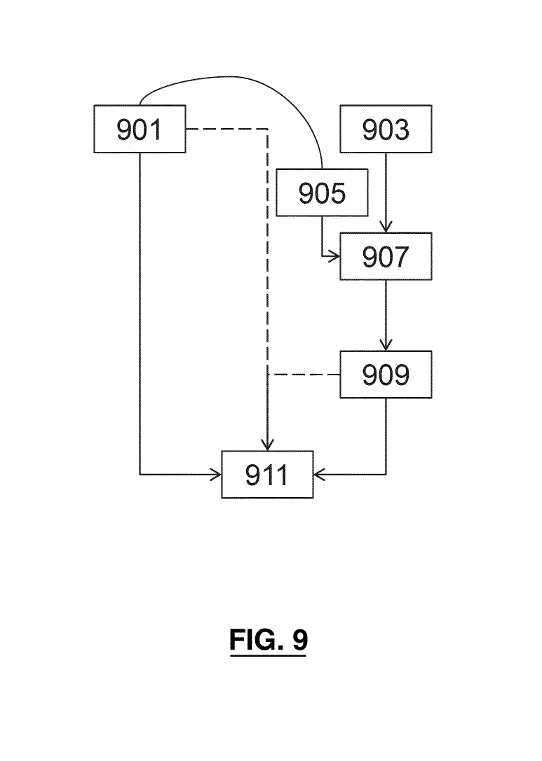

Referring now to FIG. 9, a method of overlapping the physical image stream with the rendered image stream is shown. At block 901, the at least one image camera captures the physical image stream of the physical environment. As the at least one image camera captures the physical image stream, the processor determines, at block 903, the real-time orientation and location of the HMD in the physical environment. Parameters corresponding to the field of view of the at least one image camera, and the position and orientation of the at least one image camera relative to the HMD are defined in a memory, at block 905. At block 907, the processor determines the region of the physical environment lying within the field of view of the at least one image camera in real-time using the real-time orientation and location of the HMD, as well as the defined parameters for the at least one image camera. At block 909, the processor generates a rendered image stream comprising rendered CGI within a region of the map of the physical environment corresponding to the region of the physical environment lying within the field of view of the at least one image camera. The region in the rendered image stream may be understood as a region within the field of view of a notional camera having the same orientation, location and field of view in the map as the at least one image camera has in the physical environment, since the map is generated with reference to the physical environment. At block 911, the display system of the HMD obtains the rendered and physical image streams and simultaneously displays both. The physical image stream may be provided directly to the display system, or it may first pass to the processor for combined transmission to the display system along with the rendered image stream.

If the fields of view of the notional and physical cameras are substantially aligned and identical, simultaneous and combined display of both image streams provides a combined stream that is substantially matched.

In embodiments, the processor may increase or decrease the signal strength of one or the other of the physical and rendered image streams to vary the effective transparency.

In embodiments, the processor only causes the display system to display the physical image stream upon the user selecting display of the physical image stream. In further embodiments, the processor causes the display system to display the physical image stream in response to detecting proximity to an obstacle in the physical environment. In still further embodiments, the processor increases the transparency of the rendered image stream in response to detecting proximity to an obstacle in the physical environment. Conversely, the processor may reduce the transparency of the rendered image stream as the HMD moves away from obstacles in the physical environment.

In still further embodiments, the display system displays the physical and rendered image streams according to at least two of the techniques described herein.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

What is claimed is:

1. A method for mapping a physical environment in which a user wearing a wearable display for augmented reality is situated, the method comprising:
(a) capturing, by at least one depth camera disposed upon the user, depth information for the physical environment;
(b) by a processor, obtaining the depth information, determining the orientation of the at least one depth camera relative to the wearable display, and assigning coordinates for the depth information in a map of the physical environment based on the orientation of the at least one depth camera;
wherein:
i) the capturing comprises continuously capturing a sequence of frames of depth information for the physical environment during rotation and translation of the at least one depth camera in the physical environment;
ii) the obtaining further comprises continuously determining the translation and the rotation of the at least one depth camera between each of the frames, and;
iii) the assigning comprises assigning first coordinates to the depth information from a first frame and assigning subsequent coordinates to the depth information from each of the subsequent frames according to the rotation and translation of the at least one depth camera between each of the frames.

2. (canceled)

3. The method of claim 1, further comprising:
(a) identifying topography shared between first and second ones of subsequent frames;
(b) assigning shared coordinates to the shared topography for each of the first and second ones of the subsequent frames; and
(c) assigning coordinates for the second one of the subsequent frames with reference to the coordinates for the shared topography.

4. The method of claim 1, further comprising:
(a) capturing, by at least one image camera disposed upon the user, a physical image stream of the physical environment;
(b) obtaining the physical image stream, determining the orientation of the at least one image camera relative to the wearable display, and assigning coordinates to a plurality of pixels in the physical image stream in the map of the physical environment based on the orientation of the at least one image camera.

5. A system for mapping a physical environment surrounding a user wearing a wearable display for augmented reality, the system comprising:
(a) at least one depth camera disposed upon the user, to capture depth information for the physical environment;
(b) at least one processor in communication with the at least one depth camera, to obtain the depth information from the at least one depth camera, determine the orientation of the at least one depth camera relative to the wearable display, and assign coordinates for the depth information in a map of the physical environment based on the orientation of the at least one depth camera;
wherein the at least one depth camera is configured to continuously capture a sequence of frames of depth information for the physical environment during rotation and translation of the at least one depth camera in the physical environment, and the processor is configured to:
i) continuously determine the rotation and the translation of the at least one depth camera between each of the frames;
ii) assign coordinates for the depth information by assigning first coordinates to the depth information from a first frame and assigning subsequent coordinates to the depth information from each of the subsequent frames according to the rotation and translation of the at least one depth camera between each of the frames.

6. (canceled)

7. The system of claim 5, wherein the processor is further configured to:
(a) identify topography shared between first and second ones of subsequent frames;
(b) assign shared coordinates to the shared topography for each of the first and second ones of the subsequent frames; and
(c) assign coordinates for the second one of the subsequent frames with reference to the coordinates for the shared topography.

8. The system of claim 5, further comprising at least one image camera disposed upon the user, operable to capture a physical image stream of the physical environment, and wherein the processor is configured to:
(a) obtain the physical image stream, determine the orientation of the at least one image camera relative to the wearable display; and
(b) assign coordinates to a plurality of pixels in the physical image stream in the map of the physical environment based on the orientation of the at least one image camera.

9. (canceled)

10. (canceled)
